(19) United States
(12) Patent Application Publication
(10) Pub. No.: US 2017/0216971 A1
(43) Pub. Date: Aug. 3, 2017

(54) USE OF VARIABLE WAVELENGTH LASER ENERGY FOR CUSTOM ADDITIVE MANUFACTURING

(71) Applicant: LAWRENCE LIVERMORE NATIONAL SECURITY, LLC, Livermore, CA (US)

(72) Inventors: James A. DeMuth, Livermore, CA (US); Kevin J. Kramer, Redmond, WA (US)

(21) Appl. No.: 15/008,702

(22) Filed: Jan. 28, 2016

(51) Int. Cl. B23K 26/342; B23K 26/144

(52) U.S. Cl. CPC B23K 26/342; B23K 26/144; B33Y 10/00

(57) ABSTRACT

A laser-based additive manufacturing system tailored to be material specific based on the laser wavelength or frequency used. The system adjusts the frequency/wavelength of the laser during the process to improve coupling efficiency and/or tailor heating and cooling profiles of different materials.

### STATEMENT AS TO RIGHTS TO APPLICATIONS MADE UNDER FEDERALLY SPONSORED RESEARCH AND DEVELOPMENT

The United States Government has rights in this application pursuant to Contract No. DE-AC52-07NA27344 between the United States Department of Energy and Lawrence Livermore National Security, LLC for the operation of Lawrence Livermore National Laboratory.

### BACKGROUND

Field of Endeavor

The present application relates to additive manufacturing and more particularly to the use of variable wavelength laser energy for additive manufacturing.

State of Technology

This section provides background information related to the present disclosure which is not necessarily prior art.

U.S. Pat. No. 4,944,817 for multiple material systems for selective beam sintering issued Jul. 31, 1990 to David L. Bourell et al and assigned to Board of Regents, The University of Texas System provides the state of technology information reproduced below.

A method and apparatus for selectively sintering a layer of powder to produce a part comprising a plurality of sintered layers. The apparatus includes a computer controlling a laser to direct the laser energy onto the powder to produce a sintered mass. The computer either determines or is programmed with the boundaries of the desired cross-sectional regions of the part. For each cross-section, the aim of the laser beam is scanned over a layer of powder and the beam is switched on to sinter only the powder within the boundaries of the cross-section. Powder is applied and successive layers sintered until a completed part is formed.

U.S. Pat. No. 5,155,324 for a method for selective laser sintering with layerwise cross-scanning issued Oct. 12, 1992 to Carl R, Deckard et al, University of Texas at Austin, provides the state of technology information reproduced below.

Selective laser sintering is a relatively new method for producing parts and other freeform solid articles in a layer-by-layer fashion. This method forms such articles by the mechanism of sintering, which refers to a process by which particulates are made to form a solid mass through the application of external energy. According to selective laser sintering, the external energy is focused and controlled by controlling the laser to sinter selected locations of a heat-fusible powder. By performing this process in layer-by-layer fashion, complex parts and freeform solid articles which cannot be fabricated easily (if at all) by subtractive methods such as machining can be quickly and accurately fabricated. Accordingly, this method is particularly beneficial in the production of prototype parts, and is particularly useful in the customized manufacture of such parts and articles in a unified manner directly from computer-aided-design (CAD) or computer-aided-manufacturing (CAM) data bases.

Selective laser sintering is performed by depositing a layer of a heat-fusible powder onto a target surface; examples of the types of powders include metal powders, polymer powders such as wax that can be subsequently used in investment casting, ceramic powders, and plastics such as ABS plastic, polyvinyl chloride (PVC), polycarbonate and other polymers. Portions of the layer of powder corresponding to a cross-sectional layer of the part to be produced are exposed to a focused and directionally controlled energy beam, such as generated by a laser having its direction controlled by mirrors, under the control of a computer. The portions of the powder exposed to the laser energy are sintered into a solid mass in the manner described hereinabove. After the selected portions of the layer have been so sintered or bonded, another layer of powder is placed over the layer previously selectively sintered, and the energy beam is directed to sinter portions of the new layer according to the next cross-sectional layer of the part to be produced. The sintering of each layer not only forms a solid mass within the layer, but also sinters each layer to previously sintered powder underlying the newly sintered portion. In this manner, the selective laser sintering method builds a part in layer-wise fashion, with flexibility, accuracy, and speed of fabrication superior to conventional machining methods.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

The inventors' apparatus, systems, and methods provide a laser-based additive manufacturing system wherein the system can be tailored to be material specific based on the laser wavelength or frequency used. The inventors' apparatus, systems, and methods operate by adjusting the frequency/wavelength during the process to improve coupling efficiency and/or tailor heating and cooling profiles of different materials. The inventors' apparatus, systems, and methods use various wavelengths of photonic excitation to melt various materials that are specifically tuned to the material. This is especially important for efficiency when performing multi-material printing and/or to maximize material throughput capacity and machine efficiency for SLS, SLM, DMLS, or general powder bed fusion type additive manufacturing machines.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1A illustrates the direction of multiple deposits of different metal powder particles onto a substrate.

FIG. 1B shows multiple light sources of different wavelengths directed onto the deposits of different metal powder particles on the substrate.

FIG. 1C illustrates that the solidified different deposits of metal powder particles have formed the first layer of the product.

FIG. 1D illustrates the building of a second layer upon the first layer and that the final product is completed by repeating the steps to build additional layers until the final product is completed.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

Additive manufacturing is changing the way the world makes things. It is on brink of being able to increase to production rates relative to mass manufacturing, but is still currently stuck in the prototyping/high-value-only product creation phase. There are many types of additive manufacturing, but one of the most precise systems that can handle the widest variety of materials (plastics, ceramics, and metals) is powder bed fusion (also known as DMLS, SLS, SLM, etc . . . each company brands it with their own name, but the common method description is all powder bed fusion).

Current powder bed fusion additive manufacturing systems (EOS, Concept Laser, etc . . . ) use a 100-1,000 W fiber laser (1-4 currently) to melt layers of powdered material by scanning the laser over the substrate, melting the powder and bonding it to the base in a 2D pattern. A new layer of powder is then spread across the layer and a new arbitrary pattern is applied to the powder using the laser. These lasers are continuous wave systems; and thus are scanned around the build platform with some spot size, power, and velocity that is material dependent in order to achieve the correct melt characteristics.

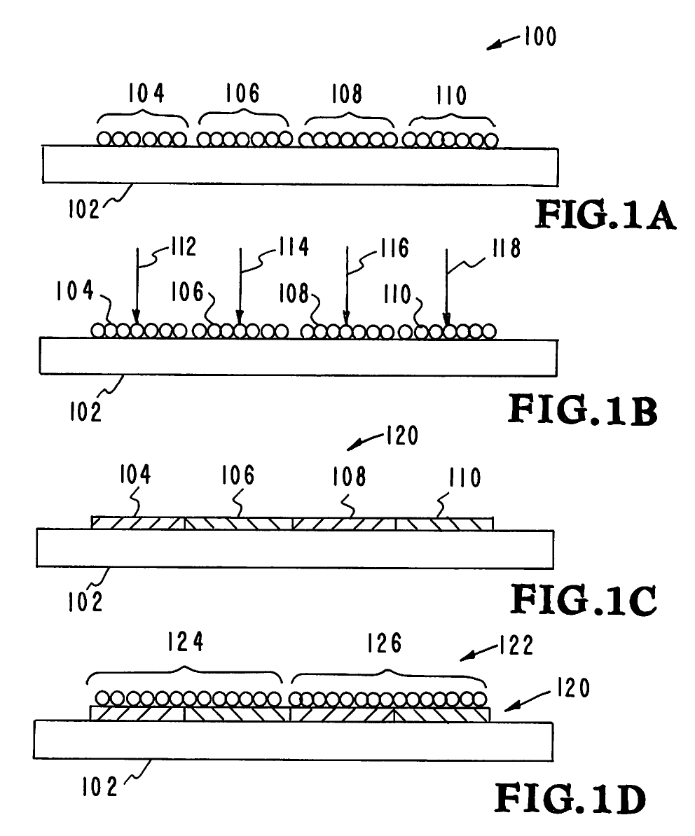

Referring now to the drawings and in particular to FIGS. 1A through 1D, one embodiment of the inventors' apparatus, systems, and methods is illustrated. This embodiment is designated generally by the reference numeral 100. The embodiment 100 includes the components listed and described below.
Substrate 102.
First metal powder particles 104.
Second metal powder particles 106.
Third metal powder particles 108.
Fourth metal powder particles 110.
Light source of first wavelength 212.
Light source of second wavelength 214.
Light source of third wavelength 216.
Light source of fourth wavelength 218.
Completed first layer 120.
Second layer 122.
Second layer set of particles 124.
Second layer set of particles 126.

The embodiment 100 is an additive manufacturing system that is be tailored to be material specific based on the laser wavelength or frequency used. Initially a 3D model of the desired product is designed by any suitable method, e.g., by bit mapping or by computer aided design (CAD) software at a PC/controller. The CAD model of the desired product is electronically sliced into series of 2-dimensional data files, i.e. 2D layers, each defining a planar cross section through the model of the desired product. The 2-dimensional data files are stored in a computer and provide a digital image of the final product. The digital images are used in the additive manufacturing system to produce the final product. Powder particles are applied to a substrate and solidified in a layer by layer process to produce the final product. The digital image of the first 2D layer is used to produce the first layer of the desired product. The inventors have developed an additive manufacturing apparatus for producing a product wherein the apparatus includes a substrate, a first set of powder particles made of a first material deposited on the substrate, a second set of powder particles made of a second material deposited on the substrate, a first energetic beam of a first wavelength directed onto the first set of powder particles that fuses the first set of powder particles on the substrate, a second energetic beam of a second wavelength directed onto the second set of powder particles that fuses the second set of powder particles on the substrate to form a first layer of the product, a third set of powder particles made of a third material deposited on the first layer, a fourth set of powder particles made of a fourth material deposited on the first layer, a third energetic beam of a third wavelength directed onto the third set of powder particles that fuses the third set of powder particles on the first layer, a fourth energetic beam of a fourth wavelength directed onto the fourth set of powder particles that fuses the fourth set of powder particles on the first layer to form a second layer of the product, and additional powder particles and additional energetic beams that produce additional layers and complete the product.

As shown in FIG. 1A, a delivery system directs multiple deposits of different metal powder particles onto a substrate 102. Four different deposits of metal powder particles 104, 106, 108 and 110 are illustrated in FIG. 1A; however it is to be understood that additional or fewer deposits of metal powder particles can be used.

Referring now to FIG. 1B, multiple light sources of different wavelengths 112, 114, 116, and 118 are directed onto the deposits of metal powder particles 104, 106, 108 and 110 respectively. The digital image of the first 2D layer is used to produce the first layer of the desired product.

Referring now to FIG. 1C, the multiple light sources of different wavelengths 112, 114, 116, and 118 have been directed onto the metal powder particles 104, 106, 108 and 110. The multiple light sources of different wavelengths have solidified the four different deposits of metal powder particles 104, 106, 108 and 110. The solidified different deposits of metal powder particles 104, 106, 108 and 110 form the first layer 120 of the product.

Referring now to FIG. 1D, the building of a second layer 122 upon the first layer 120 is illustrated. The second layer 122 is made up of two different deposits of metal powder particles 124 and 126. Two different light sources of different wavelengths are used to solidify the two different deposits of metal powder particles 124 and 126 to form the second layer 122 of the product. The final product is completed by repeating the steps to build additional layers until the final product is completed. The embodiment 100 provides an additive manufacturing method for producing a product including the steps of providing a substrate, depositing multiple sets of initial powder particles on said substrate wherein each set is made of a different material, directing multiple light source beams onto said multiple sets of initial powder particles on said substrate to fuse said multiple sets of initial powder particles on said substrate and form a first layer of the product, depositing multiple sets of secondary powder particles on said first layer of the product wherein each set is made of a different material, directing multiple light source beams onto said multiple sets of secondary powder particles on said first layer to fuse said multiple sets of secondary powder particles on said first layer and form a second layer of the product, and repeating said steps to provide additional layers and complete the product.

The inventors' apparatus, systems, and methods use various wavelengths of photonic excitation to melt various materials that are specifically tuned to the material. This is especially important for efficiency when performing multi-material printing and/or to maximize material throughput capacity and machine efficiency for SLS, SLM, DMLS, or general powder bed fusion machines. The light source beams can be carbon dioxide laser beams, neodymium-doped yttrium aluminum garnet laser beams or other laser beams. The laser beams can have different wavelengths or frequencies.

Although the description above contains many details and specifics, these should not be construed as limiting the scope of the application but as merely providing illustrations of some of the presently preferred embodiments of the apparatus, systems, and methods. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

The claims are:

1. An additive manufacturing method for producing a product, comprising the steps of:
providing a substrate,
depositing multiple sets of initial powder particles on said substrate wherein each set is made of a different material,
directing multiple energetic beams onto said multiple sets of initial powder particles on said substrate to fuse said multiple sets of initial powder particles on said substrate and form a first layer of the product,
depositing multiple sets of secondary powder particles on said first layer of the product wherein each set is made of a different material,
directing multiple energetic beams onto said multiple sets of secondary powder particles on said first layer to fuse said multiple sets of secondary powder particles on said first layer and form a second layer of the product, and
repeating said steps to provide additional layers and complete the product.

2. The additive manufacturing method for producing a product of claim 1 wherein said step of directing a multiple energetic beams onto said multiple sets of initial powder particles on said substrate to fuse said multiple sets of initial powder particles on said substrate and form a first layer of the product comprises directing multiple laser beams onto said multiple sets of initial powder particles on said substrate to fuse said multiple sets of initial powder particles on said substrate and form a first layer of the product.

3. The additive manufacturing method for producing a product of claim 1 wherein said step of directing a multiple energetic beams onto said multiple sets of initial powder particles on said substrate to fuse said multiple sets of initial powder particles on said substrate and form a first layer of the product comprises directing multiple carbon dioxide laser beams onto said multiple sets of initial powder particles on said substrate to fuse said multiple sets of initial powder particles on said substrate and form a first layer of the product.

4. The additive manufacturing method for producing a product of claim 1 wherein said step of directing a multiple energetic beams onto said multiple sets of initial powder particles on said substrate to fuse said multiple sets of initial powder particles on said substrate and form a first layer of the product comprises directing multiple neodymium-doped yttrium aluminum garnet laser beams onto said multiple sets of initial powder particles on said substrate to fuse said multiple sets of initial powder particles on said substrate and form a first layer of the product.

5. The additive manufacturing method for producing a product of claim 1 wherein said step of directing a multiple energetic beams onto said multiple sets of initial powder particles on said substrate to fuse said multiple sets of initial powder particles on said substrate and form a first layer of the product comprises directing multiple energetic beams of different wavelengths onto said multiple sets of initial powder particles on said substrate to fuse said multiple sets of initial powder particles on said substrate and form a first layer of the product.

6. The additive manufacturing method for producing a product of claim 1 wherein said step of directing multiple energetic beams onto said multiple sets of initial powder particles on said substrate to fuse said multiple sets of initial powder particles on said substrate and form a first layer of the product comprises directing a multiple energetic beams of different frequencies onto said multiple sets of initial powder particles on said substrate to fuse said multiple sets of initial powder particles on said substrate and form a first layer of the product.

7. The additive manufacturing method for producing a product of claim 1 wherein said step of directing a multiple energetic beams onto said multiple sets of secondary powder particles on said substrate to fuse said multiple sets of secondary powder particles on said first layer and form a second layer of the product comprises directing multiple laser beams onto said multiple sets of secondary powder particles on said first layer to fuse said multiple sets of secondary powder particles on said first layer and form a second layer of the product.

8. The additive manufacturing method for producing a product of claim 1 wherein said step of directing a multiple energetic beams onto said multiple sets of secondary powder particles on said substrate to fuse said multiple sets of secondary powder particles on said first layer and form a second layer of the product comprises directing multiple carbon dioxide laser beams onto said multiple sets of secondary powder particles on said first layer to fuse said multiple sets of secondary powder particles on said first layer and form a second layer of the product.

9. The additive manufacturing method for producing a product of claim 1 wherein said step of directing a multiple energetic beams onto said multiple sets of secondary powder particles on said substrate to fuse said multiple sets of secondary powder particles on said first layer and form a second layer of the product comprises directing multiple neodymium-doped yttrium aluminum garnet laser beams onto said multiple sets of secondary powder particles on said first layer to fuse said multiple sets of secondary powder particles on said first layer and form a second layer of the product.

10. The additive manufacturing method for producing a product of claim 1 wherein said step of directing a multiple energetic beams onto said multiple sets of secondary powder particles on said substrate to fuse said multiple sets of secondary powder particles on said first layer and form a second layer of the product comprises directing multiple energetic beams of different wavelengths onto said multiple sets of secondary powder particles on said first layer to fuse said multiple sets of secondary powder particles on said first layer and form a second layer of the product.

11. The additive manufacturing method for producing a product of claim 1 wherein said step of directing a multiple energetic beams onto said multiple sets of secondary powder particles on said substrate to fuse said multiple sets of secondary powder particles on said first layer and form a second layer of the product comprises directing multiple energetic beams of different frequencies onto said multiple sets of secondary powder particles on said first layer to fuse said multiple sets of secondary powder particles on said first layer and form a second layer of the product.

12. An additive manufacturing method for producing a product, comprising the steps of:
providing a substrate,
depositing a first set of powder particles made of a first material on said substrate,
depositing a second set of powder particles made of a second material on said substrate,
directing a first energetic beam of a first wavelength onto said first set of powder particles to fuse said first set of powder particles on said substrate,
directing a second energetic beam of a second wavelength onto said second set of powder particles to fuse said second set of powder particles on said substrate to form a first layer of the product,
depositing a third set of powder particles made of a third material on said first layer,
depositing a fourth set of powder particles made of a fourth material on said first layer,
directing a third energetic beam of a third wavelength onto said third set of powder particles to fuse said third set of powder particles on said first layer,
directing a fourth energetic beam of a fourth wavelength onto said fourth set of powder particles to fuse said fourth set of powder particles on said first layer to form a second layer of the product, and
repeating said steps to provide additional layers and complete the product.

13. The additive manufacturing method for producing a product of claim 12
wherein said step of directing a first energetic beam of a first wavelength onto said first set of powder particles to fuse said first set of powder particles on said substrate comprises directing a first laser beam of a first wavelength onto said first set of powder particles to fuse said first set of powder particles on said substrate, and
wherein said step of directing a second energetic beam of a second wavelength onto said first set of powder particles to fuse said first set of powder particles on said substrate comprises directing a second laser beam of a second wavelength onto said first set of powder particles to fuse said first set of powder particles on said substrate.

14. The additive manufacturing method for producing a product of claim 12
wherein said step of directing a first energetic beam of a first wavelength onto said first set of powder particles to fuse said first set of powder particles on said substrate comprises directing a first carbon dioxide laser beam of a first wavelength onto said first set of powder particles to fuse said first set of powder particles on said substrate, and
wherein said step of directing a second energetic beam of a second wavelength onto said first set of powder particles to fuse said first set of powder particles on said substrate comprises directing a second carbon dioxide laser beam of a second wavelength onto said first set of powder particles to fuse said first set of powder particles on said substrate.

15. The additive manufacturing method for producing a product of claim 12
wherein said step of directing a first energetic beam of a first wavelength onto said first set of powder particles to fuse said first set of powder particles on said substrate comprises directing a first neodymium-doped yttrium aluminum garnet laser beam of a first wavelength onto said first set of powder particles to fuse said first set of powder particles on said substrate, and
wherein said step of directing a second energetic beam of a second wavelength onto said first set of powder particles to fuse said first set of powder particles on said substrate comprises directing a second neodymium-doped yttrium aluminum garnet laser beam of a second wavelength onto said first set of powder particles to fuse said first set of powder particles on said substrate.

16. The additive manufacturing method for producing a product of claim 12
wherein said step of directing a directing a third energetic beam of a third wavelength onto said third set of powder particles to fuse said third set of powder particles on said first layer comprises directing a third laser beam of a third wavelength onto said third set of powder particles to fuse said third set of powder particles on said first layer, and
wherein said step of directing a fourth energetic beam of a fourth wavelength onto said fourth set of powder particles to fuse said fourth set of powder particles on said first layer to form a second layer of the product comprises directing a fourth laser beam of a fourth wavelength onto said fourth set of powder particles to fuse said fourth set of powder particles on said first layer to form a second layer of the product.

17. The additive manufacturing method for producing a product of claim 12
wherein said step of directing a directing a third energetic beam of a third wavelength onto said third set of powder particles to fuse said third set of powder particles on said first layer comprises directing a third carbon dioxide laser beam of a third wavelength onto said third set of powder particles to fuse said third set of powder particles on said first layer, and
wherein said step of directing a fourth energetic beam of a fourth wavelength onto said fourth set of powder particles to fuse said fourth set of powder particles on said first layer to form a second layer of the product comprises directing a fourth carbon dioxide laser beam of a fourth wavelength onto said fourth set of powder particles to fuse said fourth set of powder particles on said first layer to form a second layer of the product.

18. The additive manufacturing method for producing a product of claim 12
wherein said step of directing a directing a third energetic beam of a third wavelength onto said third set of powder particles to fuse said third set of powder particles on said first layer comprises directing a third neodymium doped yttrium aluminum garnet laser beam of a third wavelength onto said third set of powder particles to fuse said third set of powder particles on said first layer, and
wherein said step of directing a fourth energetic beam of a fourth wavelength onto said fourth set of powder particles to fuse said fourth set of powder particles on said first layer to form a second layer of the product comprises directing a fourth neodymium doped yttrium aluminum garnet beam of a fourth wavelength onto said fourth set of powder particles to fuse said fourth set of powder particles on said first layer to form a second layer of the product.

19. An additive manufacturing apparatus for producing a product, comprising:
a substrate,
a first set of powder particles made of a first material deposited on said substrate,
a second set of powder particles made of a second material deposited on said substrate,
a first energetic beam of a first wavelength directed onto said first set of powder particles that fuses said first set of powder particles on said substrate,
a second energetic beam of a second wavelength directed onto said second set of powder particles that fuses said second set of powder particles on said substrate to form a first layer of the product,
a third set of powder particles made of a third material deposited on said first layer,
a fourth set of powder particles made of a fourth material deposited on said first layer,
a third energetic beam of a third wavelength directed onto said third set of powder particles that fuses said third set of powder particles on said first layer,
a fourth energetic beam of a fourth wavelength directed onto said fourth set of powder particles that fuses said fourth set of powder particles on said first layer to form a second layer of the product, and additional powder particles and additional energetic beams that produce additional layers and complete the product.

20. The additive manufacturing apparatus for producing a product of claim 19
wherein said first energetic beam of a first wavelength is a first laser beam,
wherein said second energetic beam of a second wavelength is a second laser beam,
wherein said third energetic beam of a third wavelength is a third laser beam, and
wherein said fourth energetic beam of a fourth wavelength is a fourth laser beam.
